(19) United States
(12) Patent Application Publication
(10) Pub. No.: US 2026/0318725 A1
(43) Pub. Date: Oct. 15, 2026

(54) FLOW VELOCITY MEASURING CHIP, FLOWMETER, AND METHOD

(71) Applicant: NEC Corporation, Tokyo (JP)

(72) Inventor: Morio TAKAHASHI, Tokyo (JP)

(73) Assignee: NEC Corporation, Tokyo (JP)

(21) Appl. No.: 19/637,140

(22) Filed: Apr. 2, 2026

(30) Foreign Application Priority Data
Apr. 15, 2025 (JP) 2025-067106

(51) Int. Cl. G01F 1/663; G01F 1/66; G01F 1/661

(52) U.S. Cl. CPC G01F 1/663; G01F 1/661; G01F 1/662

(57) ABSTRACT

A flow velocity measuring chip includes a silicon photonic chip including a light emitting element, a radiation grating coupler, at least one light receiving grating coupler, and at least one light receiving element related to the at least one light receiving grating coupler. The light emitting element emits the measurement light, the radiation grating coupler radiates the measurement light emitted from the light emitting element toward an object to be measured on the front surface side of the flow velocity measuring chip, the at least one light receiving grating coupler receives the scattered light in which the measurement light is scattered inside the object to be measured, and the at least one light receiving element receives the scattered light received by the related at least one light receiving grating coupler.

### INCORPORATION BY REFERENCE

This application is based upon and claims the benefit of priority from Japanese patent application No. 2025-067106, filed on Apr. 15, 2025, the disclosure of which is incorporated herein in its entirety by reference.

### TECHNICAL FIELD

The present disclosure relates to a flow velocity measuring chip, a flowmeter, and a method.

### BACKGROUND ART

In a case where the light hits the fluid and is scattered, a Doppler shift occurs according to the flow velocity of the fluid, and the frequency of the scattered light changes. A flowmeter utilizing this phenomenon is a Doppler flowmeter. In the Doppler flowmeter, scattered light subjected to a Doppler shift from the fluid and scattered light from a stationary object are detected, and a beat signal obtained from these two scattered lights is analyzed to measure the flow velocity of the fluid.

Here, some Doppler flowmeters have a structure in which a Laser Diode (LD) and a Photo Diode (PD) are arranged such that optical axes of the LD and the PD intersect at a position where scattered light is generated. However, in general, the LD emits light from an element end face, and the PD receives light from the element surface or the element end face, and hence in this structure, the LD and the PD need to be mounted three-dimensionally. In addition, in this structure, since the volumes of the LD and the PD are large and the thickness is required, there is a limit to downsizing and thinning of the Doppler flowmeter.

Therefore, in recent years, Silicon Photonics (SiPh) technology for integrating optical elements and optical waveguides on a silicon substrate has been introduced into the field of Doppler flowmeter, and studies have been conducted to reduce the size and thickness of the Doppler flowmeter.

For example, JP 2015-172540 A discloses a technique of configuring a Doppler flowmeter using a flow velocity measuring chip in which an optical element such as a PD and an optical waveguide are integrated on a silicon substrate by the SiPh technology.

### SUMMARY

However, in the flow velocity measuring chip disclosed in JP 2015-172540 A, the LD is not provided, and the LD needs to be provided separately from the flow velocity measuring chip. Therefore, there is room for further reducing the size of the Doppler flowmeter using the flow velocity measuring chip disclosed in JP 2015-172540 A.

Therefore, in view of the above-described problems, an example object of the present disclosure is to provide a flow velocity measuring chip, a flowmeter, and a method that can contribute to further downsizing of a flowmeter using the flow velocity measuring chip.

A flow velocity measuring chip according to an example aspect is a flow velocity measuring chip used for measuring a flow velocity of a fluid flowing in an object to be measured, the flow velocity measuring chip including

a silicon photonic chip including a light emitting element, a radiation grating coupler, at least one light receiving grating coupler, and at least one light receiving element related to the at least one light receiving grating coupler, in which

the light emitting element emits measurement light,

the radiation grating coupler radiates the measurement light emitted from the light emitting element toward the object to be measured on a front surface side of the flow velocity measuring chip,

the at least one light receiving grating coupler receives scattered light in which the measurement light is scattered inside the object to be measured, and

the at least one light receiving element receives the scattered light received by the related at least one light receiving grating coupler.

A flowmeter according to an example aspect includes

the flow velocity measuring chip, and

a collimator lens arranged above the radiation grating coupler and the at least one light receiving grating coupler on a front surface side of the flow velocity measuring chip.

A method according to an example aspect is executed by a flow velocity measuring chip used for measuring a flow velocity of a fluid flowing in an object to be measured, in which

the flow velocity measuring chip is configured by

a silicon photonic chip including a light emitting element, a radiation grating coupler, at least one light receiving grating coupler, and at least one light receiving element related to the at least one light receiving grating coupler, and

the method includes

emitting measurement light from the light emitting element,

radiating, by the radiation grating coupler, the measurement light emitted from the light emitting element toward the object to be measured on a front surface side of the flow velocity measuring chip,

receiving, by the at least one light receiving grating coupler, scattered light in which the measurement light is scattered inside the object to be measured, and

receiving, by the at least one light receiving element, the scattered light received by the related at least one light receiving grating coupler.

According to the above-described aspect, an effect is obtained in that the flow velocity measuring chip that contributes to further downsizing of the flowmeter using the flow velocity measuring chip, the flowmeter, and the method can be provided.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a perspective view illustrating a configuration example of a flow velocity measuring chip according to the present disclosure;

FIG. 2 is a plan view illustrating a configuration example of the flow velocity measuring chip according to the present disclosure;

FIG. 3 is a plan view illustrating a configuration example of the flow velocity measuring chip according to the present disclosure;

FIG. 4 is a plan view illustrating a modified configuration example of the flow velocity measuring chip illustrated in FIG. 3;

FIG. 5 is a plan view illustrating a modified configuration example of the flow velocity measuring chip illustrated in FIG. 3;

FIG. 6 is a plan view illustrating a configuration example of the flow velocity measuring chip according to the present disclosure;

FIG. 7 is a side cross-sectional view illustrating a configuration example of a part of the Doppler flowmeter using the flow velocity measuring chip illustrated in FIG. 6;

FIG. 8 is a side cross-sectional view illustrating a modified configuration example of the flow velocity measuring chip illustrated in FIG. 6;

FIG. 9 is a side cross-sectional view illustrating a configuration example of a flow velocity measuring package according to the present disclosure;

FIG. 10 is a side cross-sectional view illustrating an application example of the flow velocity measuring package illustrated in FIG. 9;

FIG. 11 is a side cross-sectional view illustrating an application example of the flow velocity measuring package illustrated in FIG. 9;

FIG. 12 is a side cross-sectional view illustrating an application example of the flow velocity measuring package illustrated in FIG. 9;

FIG. 13 is a plan view illustrating a configuration example of the flow velocity measuring chip according to the present disclosure; and

FIG. 14 is a flowchart describing an example of a flow of an operation of the flow velocity measuring chip illustrated in FIG. 13.

### EXAMPLE EMBODIMENT

Hereinafter, example embodiments and the related art of the present disclosure will be described with reference to the diagrams. In the following descriptions and drawings, omission and simplification are made as appropriate for the sake of clarity. In the following drawings, the same elements are denoted by the same reference numerals, and redundant description will be omitted as necessary. In addition, specific numerical values and the like shown below are only examples to facilitate understanding of the present disclosure, and are not limited thereto.

### First Example Embodiment

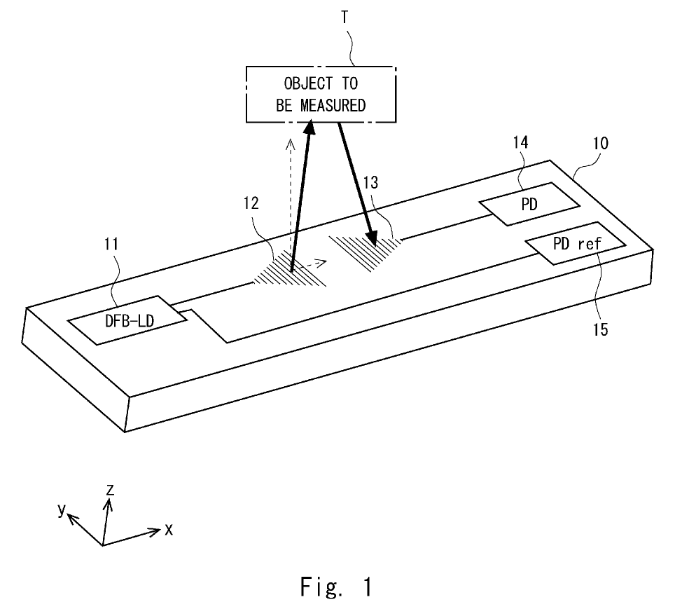

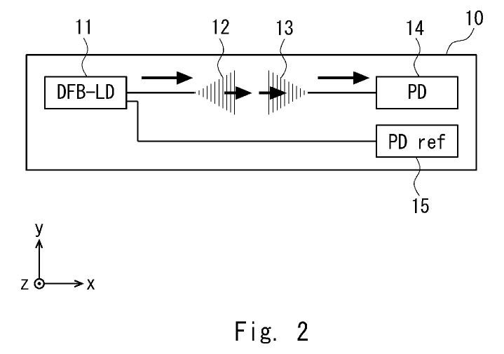

FIGS. 1 and 2 are views illustrating a configuration example of a flow velocity measuring chip 10 according to the present disclosure, in which FIG. 1 is a perspective view and FIG. 2 is a plan view. In FIGS. 1 and 2, the width direction of the flow velocity measuring chip 10 is defined as an x direction, the depth direction as a y direction, and the height direction as a z direction. In addition, it is assumed that the front surface side of the flow velocity measuring chip 10 is a plus side in the z direction, and the back surface side of the flow velocity measuring chip 10 is a minus side in the z direction (the same applies to the following drawings).

As illustrated in FIGS. 1 and 2, the flow velocity measuring chip 10 is a chip used by a Doppler flowmeter for measuring the flow velocity of the fluid flowing to an object to be measured T. For example, the object to be measured T is a human body, the fluid flowing through the human body is blood, and the flow velocity of the blood is a blood flow velocity.

The flow velocity measuring chip 10 includes a SiPh chip in which optical elements and optical waveguides are integrated on a silicon substrate by SiPh technology. In addition, the flow velocity measuring chip 10 includes, as optical elements, a Distributed Feedback (DFB) -LD 11, a radiation Grating Coupler (GC) 12, a light receiving GC 13, a PD 14, and a monitor PD 15. In FIGS. 1 and 2, the monitor PD 15 is denoted as “PD ref” (the same applies to the following drawings).

The DFB-LD 11 emits laser light as measurement light.

The radiation GC 12 is connected to the DFB-LD 11 via an optical waveguide, and radiates measurement light emitted from the DFB-LD 11 toward the object to be measured T on the front surface side of the flow velocity measuring chip 10. At this time, the radiation GC 12 emits the measurement light in a direction inclined at 10° to 20° with respect to the upward direction (the plus side in the z direction) perpendicular to the front surface of the flow velocity measuring chip 10.

The light receiving GC 13 is arranged side by side with the radiation GC 12 in a direction related to the radiation direction of the measurement light emitted from the radiation GC 12. Specifically, the direction in which the light receiving GC 13 is arranged is a plane component direction (xy component direction) of the flow velocity measuring chip 10 of the radiation direction vector of the measurement light. In the examples of FIGS. 1 and 2, the direction in which the light receiving GC 13 is arranged is a plus side in the x direction of the radiation GC 12. With such an arrangement, the light receiving GC 13 can receive scattered light in which the measurement light radiated from the radiation GC 12 is scattered inside the object to be measured T.

The PD 14 is connected to the light receiving GC 13 via an optical waveguide, and receives the scattered light received by the light receiving GC 13.

Here, the scattered light incident on the PD 14 includes scattered light subjected to a Doppler shift from the fluid flowing inside the object to be measured T and scattered light from a stationary object inside the object to be measured T. Therefore, a Central Processing Unit (CPU) (not illustrated) measures the flow velocity of the fluid by analyzing a beat signal obtained from these two scattered lights.

The monitor PD 15 is connected to the DFB-LD 11 via an optical waveguide, and receives measurement light emitted from the DFB-LD 11. A control Integrated Circuit (IC) (not illustrated) monitors the light level of the measurement light that entered the monitor PD 15, and controls the DFB-LD 11 in such a way that the light level of the measurement light that entered the monitor PD 15 becomes constant. At this time, the control IC controls the current flowing through the DFB-LD 11 to control the DFB-LD 11.

As described above, according to the first example embodiment, the flow velocity measuring chip 10 includes an SiPh chip including the DFB-LD 11, the radiation GC 12, the light receiving GC 13, the PD 14, and the monitor PD 15. That is, the DFB-LD 11 is also provided in the SiPh chip comprising the flow velocity measuring chip 10.

Therefore, the Doppler flowmeter using the flow velocity measuring chip 10 does not need to provide an LD separately from the flow velocity measuring chip 10 as in the technique disclosed in JP 2015-172540 A, which can contribute to further downsizing of the Doppler flowmeter.

### Second Example Embodiment

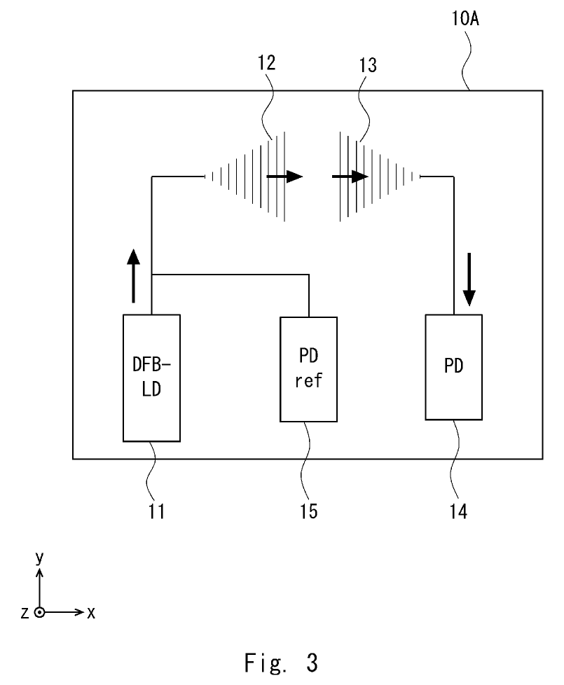

FIG. 3 is a plan view illustrating a configuration example of a flow velocity measuring chip 10A according to the present disclosure.

In the flow velocity measuring chip 10 illustrated in FIGS. 1 and 2, the PD 14 is arranged in series with the DFB-LD 11. Therefore, since the optical axis direction of the DFB-LD 11 and the optical axis direction of the PD 14 are in series, there is a possibility that the measurement light emitted from the DFB-LD 11 enters the PD 14 as stray light.

On the other hand, as illustrated in FIG. 3, in the flow velocity measuring chip 10A, the PD 14 is arranged such that the optical axis direction of the DFB-LD 11 is parallel to the optical axis direction of the PD 14. As a result, since the optical axis direction of the DFB-LD 11 and the optical axis direction of the PD 14 are not in series, the measurement light emitted from the DFB-LD 11 is avoided from entering the PD 14 as stray light.

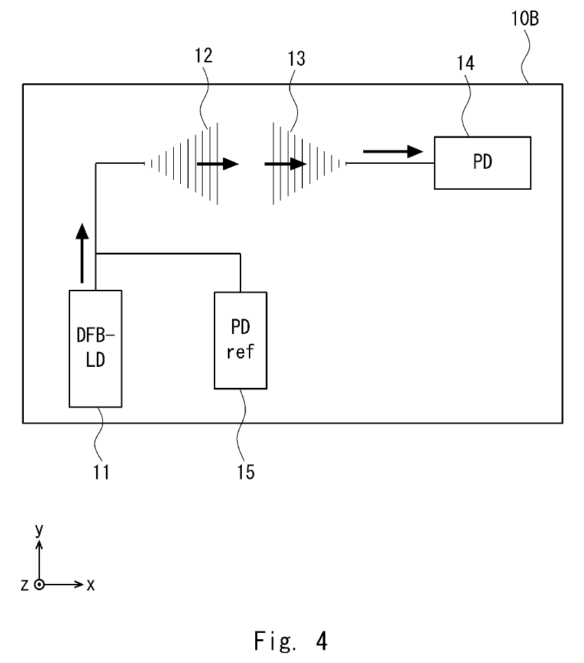

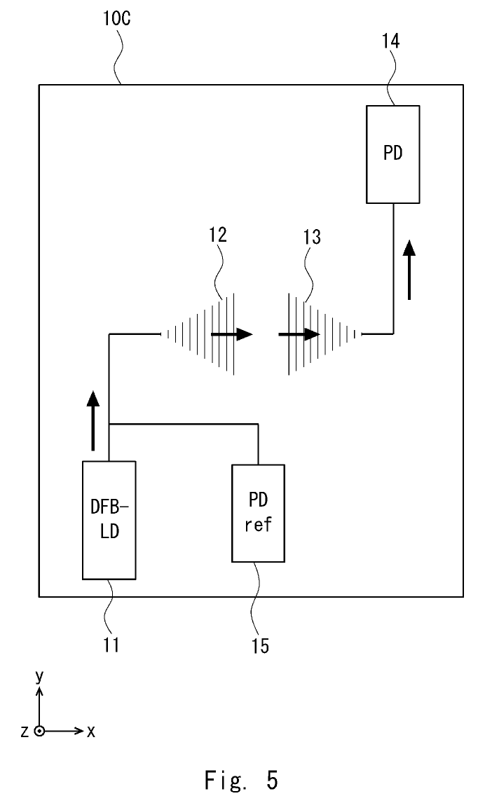

In the flow velocity measuring chip 10A, the optical axis direction of the PD 14 is not in series with the direction (the plus side in the x direction) related to the radiation direction of the measurement light, but this is not the sole case. In addition, the optical axis direction of the PD 14 is parallel to the optical axis direction of the DFB-LD 11, but this is not the sole case. That is, the PD 14 may be arranged such that the optical axis direction of the DFB-LD 11 and the optical axis direction of the PD 14 are not in series. Therefore, for example, as in a flow velocity measuring chip 10B illustrated in FIG. 4, the PD 14 may be arranged in series with the light receiving GC 13. Furthermore, as in a flow velocity measuring chip 10C illustrated in FIG. 5, the PD 14 may be arranged on the opposite side of the DFB-LD 11 with the radiation GC 12 and the light receiving GC 13 interposed therebetween. However, in consideration of the mounting surface, the flow velocity measuring chip 10A illustrated in FIG. 3 is suitable because optical elements are intensively arranged.

As described above, according to the second example embodiment, in the flow velocity measuring chips 10A, 10B, and 10C, the PD 14 is arranged such that the optical axis direction of the DFB-LD 11 and the optical axis direction of the PD 14 are not in series. Therefore, the measurement light emitted from the DFB-LD 11 is avoided from entering the PD 14 as stray light.

Other effects of the second example embodiment are similar to the effects of the first example embodiment described above.

### Third Example Embodiment

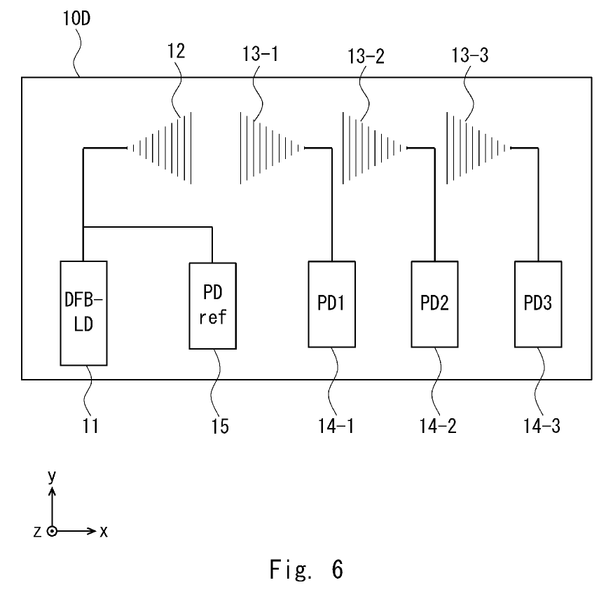

FIG. 6 is a plan view illustrating a configuration example of a flow velocity measuring chip 10D according to the present disclosure.

The flow velocity measuring chip 10A illustrated in FIG. 3 includes only one light receiving GC 13 and one PD 14.

On the other hand, as illustrated in FIG. 6, the flow velocity measuring chip 10D includes a plurality of light receiving GCs 13 and a plurality of PDs 14. Specifically, in the example of FIG. 6, the flow velocity measuring chip 10D includes three light receiving GCs 13-1 to 13-3 and three PDs 14-1 to 14-3 related to the three light receiving GCs 13-1 to 13-3. In the example of FIG. 6, the number of light receiving GCs 13 and PDs 14 is three, but the number is not limited thereto, and may be plural.

The three light receiving GCs 13-1 to 13-3 are arranged side by side in series in a direction (plus side in the x direction) related to the radiation direction of the measurement light. Therefore, each of the three light receiving GCs 13-1 to 13-3 receives scattered light in which measurement light is scattered at each distance from the front surface of the flow velocity measuring chip 10D inside the object to be measured T. This state is illustrated in FIG. 7.

FIG. 7 is a side cross-sectional view illustrating a configuration example of a part of the Doppler flowmeter using the flow velocity measuring chip 10D illustrated in FIG. 6.

As illustrated in FIG. 7, the radiation GC 12 emits measurement light in a direction inclined at 10° to 20° with respect to an upward direction (plus side in the z direction) perpendicular to the front surface of the flow velocity measuring chip 10. The light receiving GC 13-1 receives scattered light in which the measurement light is scattered at the shortest distance from the front surface of the flow velocity measuring chip 10D. The light receiving GC 13-3 receives scattered light in which the measurement light is scattered at the longest distance from the front surface of the flow velocity measuring chip 10D. As described above, since the scattered light scattered at each distance from the front surface of the flow velocity measuring chip 10D can be received, the flow velocity of the fluid at each distance can be measured.

As illustrated in FIG. 7, the lens 20 may be arranged on the upper side of the radiation GC 12 and the light receiving GCs 13-1 to 13-3 on the front surface side of the flow velocity measuring chip 10D (on the plus side in the z direction). As a result, it is possible to suppress the spread of the measurement light radiated from the radiation GC 12 and the scattered light received by the light receiving GCs 13-1 to 13-3 and to improve the measurement sensitivity. For example, the lens 20 is assumed to be a collimating lens, but is not limited thereto. In addition, the lens 20 is desirably an array type lens according to the arrangement of the radiation GC 12 and the light receiving GCs 13-1 to 13-3. The lens 20 is preferably a Fresnel lens from the viewpoint of thickness reduction. From the viewpoint of thickness reduction, the Fresnel lens desirably uses a silicon material having a high refractive index.

As described above, according to the third example embodiment, the flow velocity measuring chip 10D includes the three light receiving GCs 13-1 to 13-3 and the three PDs 14-1 to 14-3, and the three light receiving GCs 13-1 to 13-3 are arranged side by side in series in the direction related to the radiation direction of the measurement light. As a result, the scattered light scattered at each distance from the front surface of the flow velocity measuring chip 10D can be received, so that the flow velocity of the fluid at each distance can be measured.

Other effects of the present third example embodiment are similar to the effects of the first and second example embodiments described above.

In the flow velocity measuring chip 10D (similarly the flow velocity measuring chips 10, 10A, 10B, and 10C), the radiation GC 12 radiates measurement light to the front surface side of the flow velocity measuring chip 10D, but this measurement light is also radiated to the back surface side of the flow velocity measuring chip 10D. As a countermeasure, the following two countermeasures can be considered.

In the first countermeasure, an absorbing member for absorbing measurement light is attached to the back surface side of the flow velocity measuring chip 10D (similarly, the flow velocity measuring chips 10, 10A, 10B, and 10C). As a result, the measurement light is avoided from being radiated from the back surface side of the flow velocity measuring chip 10D. For example, the absorbing member may be metal film formation, high impurity dope, a black resin adhesive, or the like.

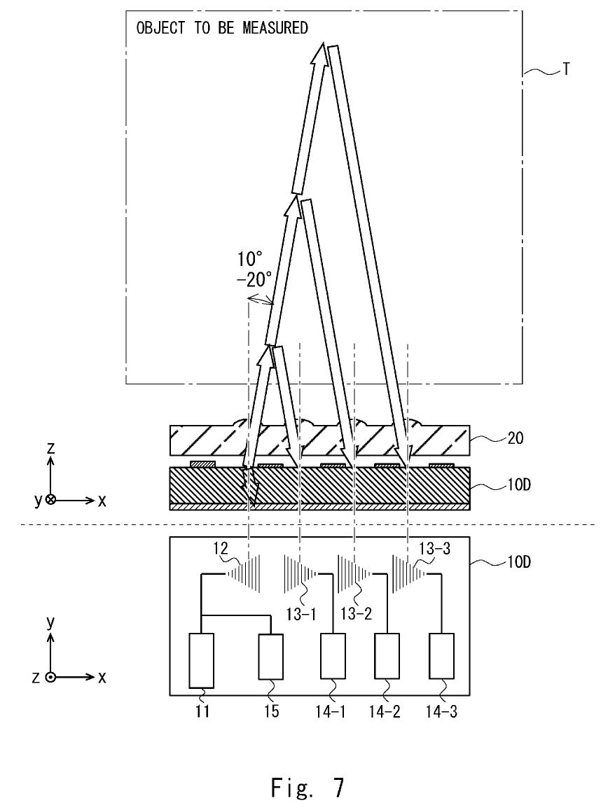

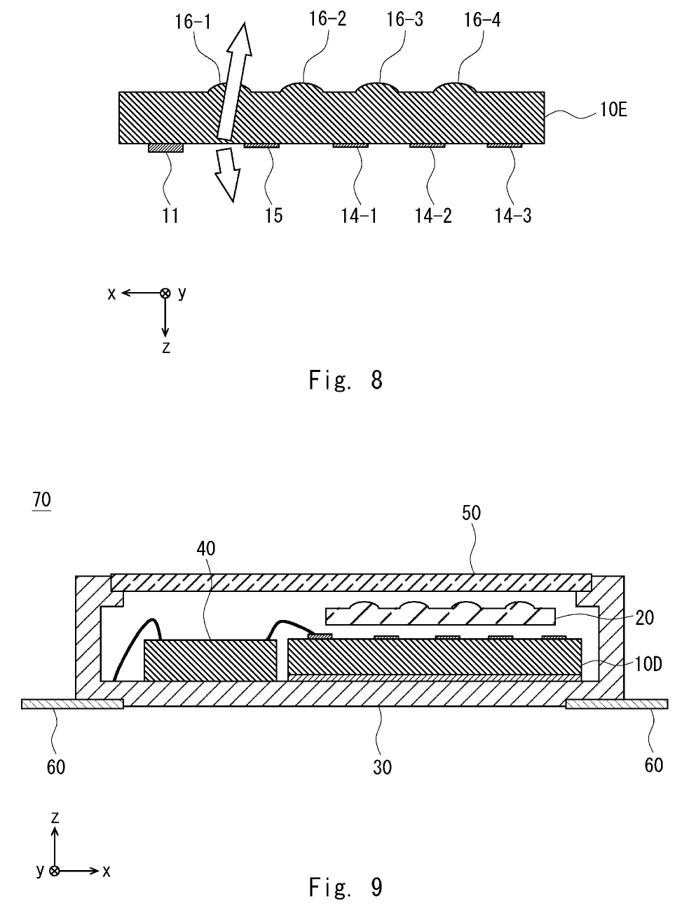

In the second countermeasure, as illustrated in FIG. 8, the flow velocity is measured using the measurement light radiated from the back surface side of a flow velocity measuring chip 10E. In this case, the silicon lenses 16-1 to 16-4 are formed on the back surface side of the flow velocity measuring chip 10E. Each of the silicon lenses 16-1 to 16-4 is a lens provided in relation with the radiation GC 12 and the light receiving GCs 13-1 to 13-3 illustrated in FIGS. 7 and 8. However, the present invention is not limited thereto, and a chip on which a silicon lens is formed may be attached to the back surface side of the flow velocity measuring chip 10E.

### Fourth Example Embodiment

FIG. 9 is a side cross-sectional view illustrating a configuration example of a flow velocity measuring package 70 according to the present disclosure. The flow velocity measuring package 70 in FIG. 9 uses the flow velocity measuring chip 10D, but is not limited thereto, and other flow velocity measuring chips 10, 10A, 10B, and 10C may be used.

As illustrated in FIG. 9, in the flow velocity measuring package 70, the flow velocity measuring chip 10D and the lens 20 illustrated in FIGS. 7 and 8, and the control IC 40 are accommodated in a housing 30. A glass 50 is placed over the housing 30 as a lid. Furthermore, the housing 30 is provided with a terminal 60.

The control IC 40 monitors the light level of the measurement light incident on the monitor PD 15, and controls the DFB-LD 11 such that the light level of the measurement light incident on the monitor PD 15 becomes constant.

A battery and a CPU are connected to the terminal 60. The battery supplies power to the flow velocity measuring chip 10D and the control IC 40. The battery may be a battery dedicated to the flow velocity measuring package 70 or a battery (e.g., a battery for movement operation, a battery for other sensor devices, etc.) also used for other applications. In addition, the CPU measures the flow velocity of the fluid at each distance from the front surface of the flow velocity measuring chip 10D by analyzing the beat signal obtained from the scattered light incident on each of the PDs 14-1 to 14-3 of the flow velocity measuring chip 10D.

Furthermore, a display element, a Light Emitting Diode (LED), a proximity communication device, or the like is also connected to the terminal 60. The display element and the LED are, for example, elements that display the flow velocity measured by the CPU. The display element may be a display element dedicated to the flow velocity measuring package 70, or may be a display element also used for other applications (e.g., a Liquid Crystal Display (LCD) used for various display applications, etc.). Furthermore, the proximity communication device is, for example, a device that transmits a flow velocity measured by the CPU to any device by proximity communication.

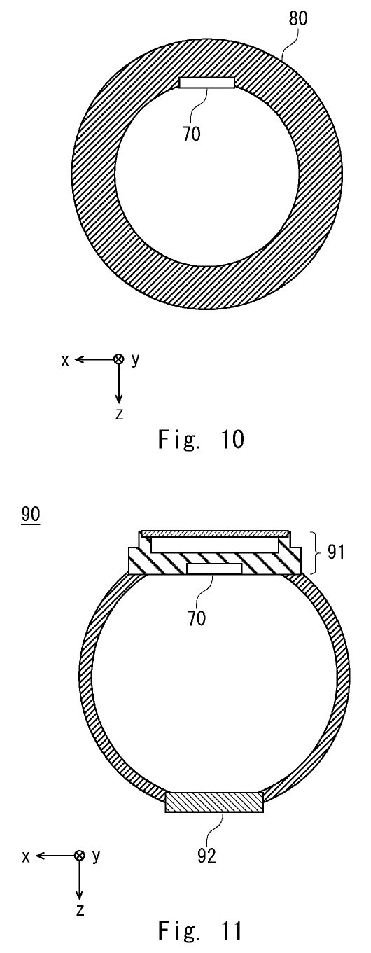

FIGS. 10 to 12 are side cross-sectional views illustrating application examples of the flow velocity measuring package 70 illustrated in FIG. 9. FIGS. 10 to 12 illustrate examples in which the flow velocity measuring package 70 is used for an application of measuring the blood flow velocity of the blood flowing through the human body, but the present invention is not limited thereto. The flow velocity measuring package 70 may be used for other applications as long as it is used for measuring the flow velocity.

In the example of FIG. 10, the flow velocity measuring package 70 is mounted on the inner side of a ring 80. In this case, the flow velocity measuring package 70 is mounted in a state where the portion of the glass 50 is directed downward (toward the plus side in the z direction).

In the example of FIG. 11, the flow velocity measuring package 70 is mounted on the inner side of a watch main body 91 of a wristwatch 90. In this case, the flow velocity measuring package 70 is mounted in a state where the portion of the glass 50 is directed downward (toward the plus side in the z direction).

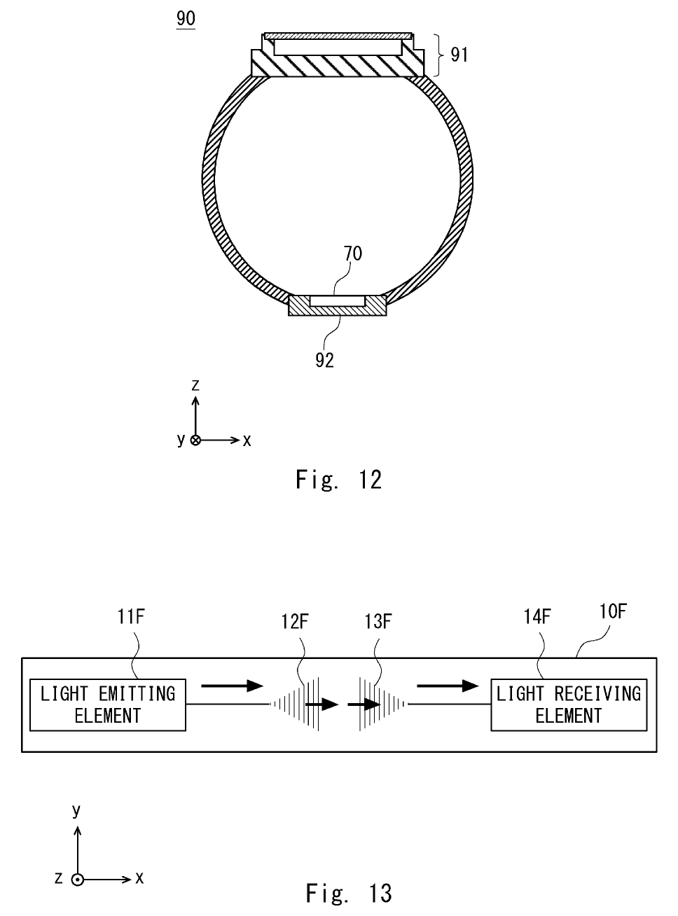

In the example of FIG. 12, the flow velocity measuring package 70 is mounted on the inner side of a buckle 92 of the wristwatch 90. In this case, the flow velocity measuring package 70 is mounted in a state where the portion of the glass 50 is directed upward (toward the plus side in the z direction).

### Fifth Example Embodiment

A fifth example embodiment is related to a superordinate example embodiment of the first to fourth example embodiments described above.

FIG. 13 is a plan view illustrating a configuration example of a flow velocity measuring chip 10F according to the present disclosure.

As illustrated in FIG. 13, the flow velocity measuring chip 10F is used for measuring the flow velocity of the fluid flowing through the object to be measured. The flow velocity measuring chip 10F includes a Silicon Photonics (SiPh) chip including a light emitting element 11F, a radiation Grating Coupler (GC) 12F, a light receiving GC 13F, and a light receiving element 14F.

The number of light receiving GCs 13F is not limited to one, and at least one light receiving GC needs to be provided. The number of light receiving elements 14F is not limited to one, and at least one light receiving element needs to be provided in relation with at least one light receiving GC 13F.

Therefore, hereinafter, description will be made assuming that at least one light receiving GC 13F and at least one light receiving element 14F are provided.

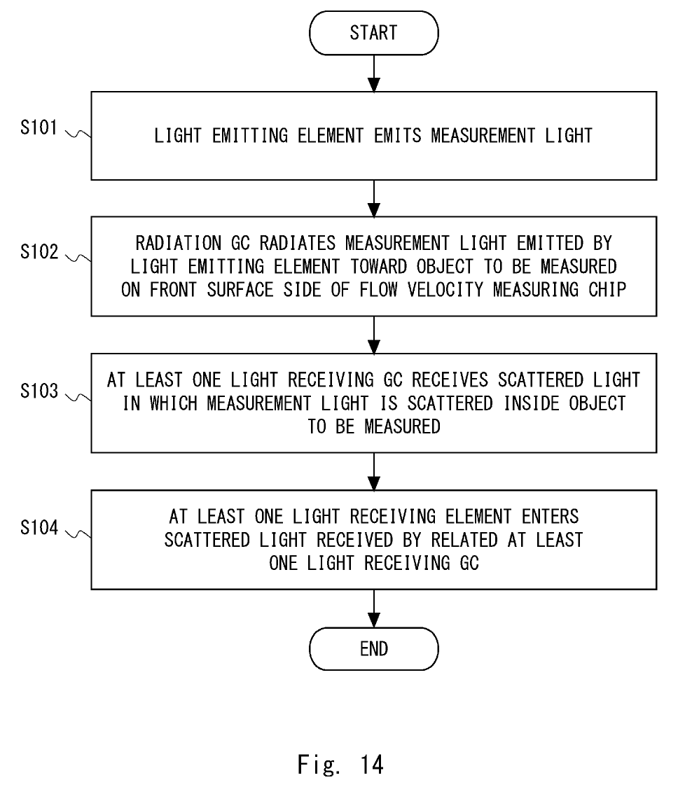

FIG. 14 is a flowchart describing an example of the flow of the operation of the flow velocity measuring chip 10F illustrated in FIG. 13.

As illustrated in FIG. 14, first, the light emitting element 11F emits measurement light (step S101). Next, the radiation GC 12F radiates the measurement light emitted from the light emitting element 11F toward the object to be measured on the front surface side of the flow velocity measuring chip 10F (step S102). Next, the at least one light receiving GC 13F receives scattered light in which the measurement light is scattered inside the object to be measured (step S103). Next, at least one light receiving element 14F receives the scattered light received by the related at least one light receiving GC 13F (step S104).

As described above, according to the fifth example embodiment, the flow velocity measuring chip 10F includes a SiPh chip including the light emitting element 11F, the radiation GC 12F, the light receiving GC 13F, and the light receiving element 14F. That is, the flow velocity measuring chip 10F is also provided with the light emitting element 11F.

Therefore, the flowmeter using the flow velocity measuring chip 10F does not need to be provided with the LD separately from the flow velocity measuring chip 10 as in the technique disclosed in JP 2015-172540 A, which can contribute to further reduction in the size of the flowmeter.

At least one light receiving GC 13F may be arranged side by side with the radiation GC 12F in a first direction related to the radiation direction of the measurement light.

Furthermore, the at least one light receiving element 14F may be arranged such that the optical axis direction of the light emitting element 11F and the optical axis direction of the at least one light receiving element 14F are not in series.

Furthermore, the at least one light receiving element 14F may be arranged such that the first direction and the optical axis direction of the at least one light receiving element 14F are not in series.

The at least one light receiving GC 13F may be a plurality of light receiving GCs 13F, and the at least one light receiving element 14F may be a plurality of light receiving elements 14F related to the plurality of light receiving GCs 13F. The plurality of light receiving GCs 13F may be arranged side by side in series in the first direction.

In addition, the flow velocity measuring chip 10F may further include

an absorbing member, attached to the back surface side of the flow velocity measuring chip 10F, for absorbing the measurement light.

Furthermore, the flowmeter may include the flow velocity measuring chip 10F and a collimator lens arranged above the radiation GC 12F and at least one light receiving GC 13F on the front surface side of the flow velocity measuring chip 10F.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely illustrative for describing one or more example embodiments. Each drawing is not associated with only one specific example embodiment, but may be associated with one or more other example embodiments. As those of ordinary skill in the art will appreciate, various features or steps described with reference to any one of the figures may be combined with features or steps shown in one or more other figures, for example, to create example embodiments that are not explicitly illustrated nor described. All of the features or steps shown in any one of the figures for describing the exemplary example embodiments are not necessarily essential, and some features or steps may be omitted. The order of the steps described in any of the drawings may be appropriately changed.

Some or all of the above example embodiments may be described as the following Supplementary Notes, but are not limited to the following.

### Supplementary Note 1

A flow velocity measuring chip used for measuring a flow velocity of a fluid flowing in an object to be measured, the flow velocity measuring chip including

a silicon photonic chip including a light emitting element, a radiation grating coupler, at least one light receiving grating coupler, and at least one light receiving element related to the at least one light receiving grating coupler, in which

the light emitting element emits measurement light,

the radiation grating coupler radiates the measurement light emitted from the light emitting element toward the object to be measured on a front surface side of the flow velocity measuring chip,

the at least one light receiving grating coupler receives scattered light in which the measurement light is scattered inside the object to be measured, and

the at least one light receiving element receives the scattered light received by the related at least one light receiving grating coupler.

### Supplementary Note 2

The flow velocity measuring chip according to supplementary note 1, in which the at least one light receiving grating coupler is arranged side by side with the radiation grating coupler in a first direction related to a radiation direction of the measurement light.

### Supplementary Note 3

The flow velocity measuring chip according to supplementary note 2, in which the at least one light receiving element is arranged such that an optical axis direction of the light emitting element and an optical axis direction of the at least one light receiving element are not in series.

### Supplementary Note 4

The flow velocity measuring chip according to supplementary note 3, in which the at least one light receiving element is arranged such that the first direction and an optical axis direction of the at least one light receiving element are not in series.

### Supplementary Note 5

The flow velocity measuring chip according to supplementary note 2, in which

the at least one light receiving grating coupler is a plurality of light receiving grating couplers,

the at least one light receiving element is a plurality of light receiving elements related to the plurality of light receiving grating couplers, and

the plurality of light receiving grating couplers are arranged side by side in series in the first direction.

### Supplementary Note 6

The flow velocity measuring chip according to supplementary note 1, further including an absorbing member, attached to a back surface side of the flow velocity measuring chip, for absorbing the measurement light.

### Supplementary Note 7

A flowmeter including

the flow velocity measuring chip according to supplementary note 1, and

a collimator lens arranged above the radiation grating coupler and the at least one light receiving grating coupler on a front surface side of the flow velocity measuring chip.

### Supplementary Note 8

A method executed by a flow velocity measuring chip used for measuring a flow velocity of a fluid flowing in an object to be measured, in which

the flow velocity measuring chip is configured by

a silicon photonic chip including a light emitting element, a radiation grating coupler, at least one light receiving grating coupler, and at least one light receiving element related to the at least one light receiving grating coupler, and

the method includes

emitting measurement light by the light emitting element,

radiating, by the radiation grating coupler, the measurement light emitted from the light emitting element toward the object to be measured on a front surface side of the flow velocity measuring chip,

receiving, by the at least one light receiving grating coupler, scattered light in which the measurement light is scattered inside the object to be measured, and

receiving, by the at least one light receiving element, the scattered light received by the related at least one light receiving grating coupler.

Some or all of the elements (e.g., configurations and functions) described in Supplementary Notes 2 to 6 dependent on Supplementary Note 1 can also depend on Supplementary Notes 7 and 8 in a similar dependency relationship as Supplementary Notes 2 to 6. Some or all of the elements that have been described in any Supplementary Note are applicable to various types of hardware, software, recording means for recording software, systems, and methods.

What is claimed is:

1. A flow velocity measuring chip used for measuring a flow velocity of a fluid flowing in an object to be measured, the flow velocity measuring chip comprising:
a silicon photonic chip including a light emitting element, a radiation grating coupler, at least one light receiving grating coupler, and at least one light receiving element related to the at least one light receiving grating coupler, wherein
the light emitting element emits measurement light,
the radiation grating coupler radiates the measurement light emitted from the light emitting element toward the object to be measured on a front surface side of the flow velocity measuring chip,
the at least one light receiving grating coupler receives scattered light in which the measurement light is scattered inside the object to be measured, and
the at least one light receiving element receives the scattered light received by the related at least one light receiving grating coupler.

2. The flow velocity measuring chip according to claim 1, wherein the at least one light receiving grating coupler is arranged side by side with the radiation grating coupler in a first direction related to a radiation direction of the measurement light.

3. The flow velocity measuring chip according to claim 2, wherein the at least one light receiving element is arranged such that an optical axis direction of the light emitting element and an optical axis direction of the at least one light receiving element are not in series.

4. The flow velocity measuring chip according to claim 3, wherein the at least one light receiving element is arranged such that the first direction and an optical axis direction of the at least one light receiving element are not in series.

5. The flow velocity measuring chip according to claim 2, wherein
the at least one light receiving grating coupler is a plurality of light receiving grating couplers,
the at least one light receiving element is a plurality of light receiving elements related to the plurality of light receiving grating couplers, and
the plurality of light receiving grating couplers are arranged side by side in series in the first direction.

6. The flow velocity measuring chip according to claim 1, further comprising an absorbing member, attached to a back surface side of the flow velocity measuring chip, for absorbing the measurement light.

7. A flowmeter comprising:
the flow velocity measuring chip according to claim 1; and
a collimator lens arranged above the radiation grating coupler and the at least one light receiving grating coupler on a front surface side of the flow velocity measuring chip.

8. A method executed by a flow velocity measuring chip used for measuring a flow velocity of a fluid flowing in an object to be measured, wherein
the flow velocity measuring chip is configured by
a silicon photonic chip including a light emitting element, a radiation grating coupler, at least one light receiving grating coupler, and at least one light receiving element related to the at least one light receiving grating coupler, and
the method comprises:
emitting measurement light by the light emitting element;
radiating, by the radiation grating coupler, the measurement light emitted from the light emitting element toward the object to be measured on a front surface side of the flow velocity measuring chip;
receiving, by the at least one light receiving grating coupler, scattered light in which the measurement light is scattered inside the object to be measured; and
receiving, by the at least one light receiving element, the scattered light received by the related at least one light receiving grating coupler.
